(19) United States
(12) Patent Application Publication
(10) Pub. No.: US 2021/0068920 A1
(43) Pub. Date: Mar. 11, 2021

(54) DENTAL FORCEPS STRUCTURE

(71) Applicant: Chao-Lin Liu, New Taipei City (TW)

(72) Inventor: Chao-Lin Liu, New Taipei City (TW)

(21) Appl. No.: 16/563,947

(22) Filed: Sep. 9, 2019

(51) Int. Cl. A61C 3/14; A61C 7/04

(52) U.S. Cl. CPC A61C 3/14; A61C 3/16; A61C 7/04

(57) ABSTRACT

A dental forceps structure, including: a fixture body, including an elastic connection portion, two elastic arms formed on two ends of the elastic connection portion, and two bended clamping portions each formed on one end of one of the elastic arms; two accommodation elements, each configured on one of the clamping portions; and two barriers, configured on the respective clamping portions and positioned between the accommodation elements and fixture body, and adapted to isolate the disturbance of surrounding tissues and organs. With the above structure, a user only needs to manually pull the elastic arms apart after placing a water suction element between the accommodation elements and place the clamping portions on the two sides of an affected part, thereby using the elastic force of the elastic connection to contract the elastic arms inward to allow the clamping portions to be naturally fixed on the affected part.

### (a) TECHNICAL FIELD OF THE INVENTION

The present invention relates to a dental forceps structure, and more particularly to a dental forceps structure, having a simple structure and convenient operation, capable of effectively fixing the position of a water suction element, preventing tongue disturbance from interfering therapy, further improving the therapeutic efficiency of physicians, providing a clear vision of the physician, and protecting patients from medical accident.

### (b) DESCRIPTION OF THE PRIOR ART

Generally, dental physicians may use various different handheld devices to carry out oral examination or treatment of dental diseases for patients; the common handheld devices are high-speed handheld unit, forceps, mouth mirrors, probes, washing machines, etc., and general dental treatments includes dental filling, filling of the gap, root canal treatment, periodontal treatment, tooth extraction, etc. In the implementation of the preparation of a decayed tooth cavity and the preparation of a tooth gap, a dentist must use one hand to hold a mouth mirror to open a patient's cheek or tongue, and another hand to hold a high-speed handheld unit to remove the tooth decay area or clean the dirt in the gap with a drill needle configured on it. If the patient's tongue is easily disturbed, the mouth mirror should be used to suppress and protect the tongue to ensure that the high-speed turning needle does not harm the patient's tongue.

After the preparation of a decayed tooth cavity and the preparation of a tooth gap are completed, a general practice is that the dentist will insert a gauze or lap into the lingual and buccal side of the affected area to isolate the affected part, dry the affected part by blowing wind, and then use composite resin to fill the cavity or gap of the decayed tooth.

The above treatment has some trouble situations. One of the trouble situations is that the patient's tongue may involuntarily disturb to push the gauze or lap out of the lingual side, or the contraction of the cheek muscles will push the gauze or lap out of the buccal side, causing the insolated area to be destroyed to cause saliva to contaminate the treatment area such that the dentist must isolate the affect part again, which wastes time or influences the accuracy of the combination of the filling material with the tooth, causing the shedding or poor fit thereof.

Another common trouble situation is that patients who are prone to laryngeal vomiting and reflexes are common in young children and some adults; such kinds of patients always cannot be inserted with gauze of lap into the lingual side when the composite resin is filled in the cavity or gap because it is easy to induce vomiting and reflex in the throat, causing gauze or lap to fall into the patient's esophagus or trachea, causing serious medical accidents and medical disputes. Therefore, the affected parts cannot be surely isolated and dried, and therapeutic effects are reduced when the cavity filling with composite resin or gap for such kinds of patients is carried out.

It is also common to use a rubber dam that is commonly used in root canal treatment as a tool for the affected part isolation upon a cavity filling or gap filling. However, the above treatment cannot be routinely used due to complicated operations, time consuming, and high material cost and because it is easy to accidentally hurt the gums when the rubber dam is clamped on the teeth, causing pain and bleeding.

### SUMMARY OF THE INVENTION

To overcome the above shortcomings and to develop a dental forceps structure, which is structurally simple and conveniently operative, can fix a water suction element effectively, accurately prevent the disturbance of a tongue from interfering therapy, provide a physician's clear operational vision, and have advantages such as patient protection and medical accident prevention, the present invention is proposed.

The main object of the present invention is in that: a lap clamp (accommodation elements) and tongue block (barriers) are in combination with the front end of forceps and placed on an affected area to block a patient's tongue involuntary disturbance with the barrier on the lingual side and stop the patient's buccal muscle contraction with the barrier on the buccal side, and a water suction element is accommodated and fixed between the accommodation elements, which can promote physicians' therapeutic efficiency, keep operation area dry, provide physicians with a clear operational vision, and more effective in preventing accidents in which the water suction element is accidentally swallowed by the patient or dropped into the trachea during the treatment.

Another object of the present invention is in that: the barrier on the buccal side can be used to open the cheek muscles before the water suction element is accommodated between the accommodation elements so as to form an isolation area during the dental treatment, and the lingual barrier is used to replace a traditional mouth mirror to ensure that a high-speed rotating drill needle will not hurt the patient's tongue.

To achieve the above objects, the present invention proposes a dental forceps structure, including: a fixture body, including an elastic connection portion, two elastic arms formed on two ends of the elastic connection portion, and two bended clamping portions each formed on one end of one of the elastic arms; two accommodation elements, each configured on one of the clamping portions; and two barriers, configured on the respective clamping portions and positioned between the accommodation elements and fixture body, and adapted to isolate the disturbance of surrounding tissues and organs.

In practical use, a user only needs to place a water suction element such as gauze or lap between the accommodation elements, and then uses the countervailing limits with a semi-cylindrical frame to fix the water suction element. Next, the elastic arms of the fixture body is manually pulled apart, and the clamping portions of the fixture body are placed on both sides of the affected part so as to contract the elastic arms inward with the elastic force of the elastic connection portion 11, allowing the clamping portions to be naturally fixed to the two sides of the affected part, thereby reducing the burden on the physician's operation and indeed positioning the water suction element, and the wetting condition of the water suction element can be observed through the hollow portion. At the same time, the barrier on the lingual side is used to prevent the disturbance of a tongue, and the outside barrier is used to open the cheek, allowing the user's operational vision to be more clear and broad, further improving the efficiency and completeness of physician's treatment, and keeping the operation area dry and effectively preventing the water suction element from being accidentally swallowed by the patient or dropped into the trachea during the treatment process.

With the above technology, the present invention can break through the problems caused by conventional dental forceps, which cannot fix gauze or lap accurately, cannot keep operation area dry, cannot accurately prevent a tongue from interfering the treatment or pushing devices, and cannot solve the problem of some adults' or children's throats being prone to vomiting and reflex in the process of dental treatment.

### BRIEF DESCRIPTION OF THE DRAWINGS

FIG. 1 is a perspective view of a preferred embodiment of the present invention;

FIG. 2 is a side view of the embodiment of the present invention;

FIGS. 3 and 4 respectively are a perspective view of the embodiment of the present invention upon implementation;

FIG. 5 is a perspective view of the embodiment of the present invention in a use state;

FIG. 6 is a perspective view of another preferred embodiment of the present invention;

FIG. 7 is a perspective view of still another preferred embodiment of the present invention in a use stat; and

FIG. 8 is an enlarged perspective view of further another preferred embodiment of the present invention in a use state.

### DETAILED DESCRIPTION OF THE PREFERRED EMBODIMENTS

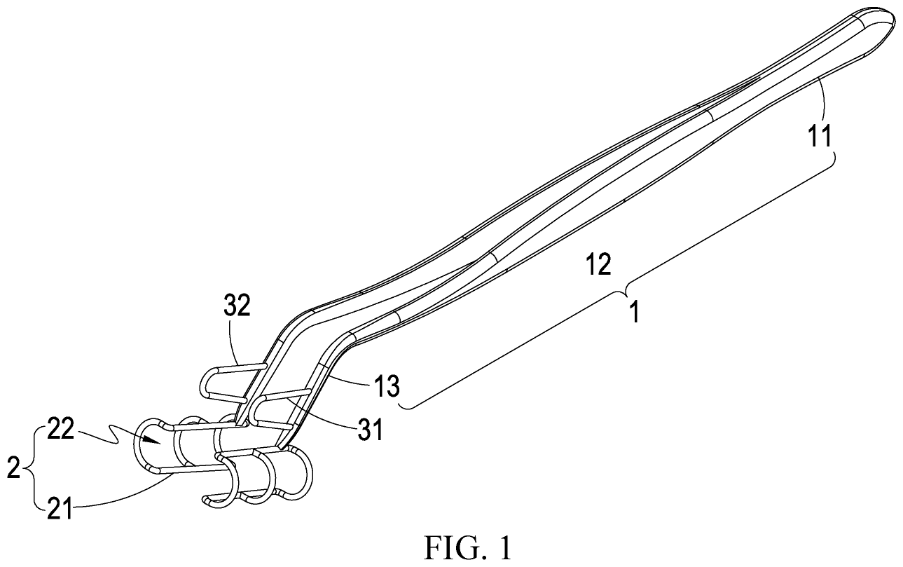

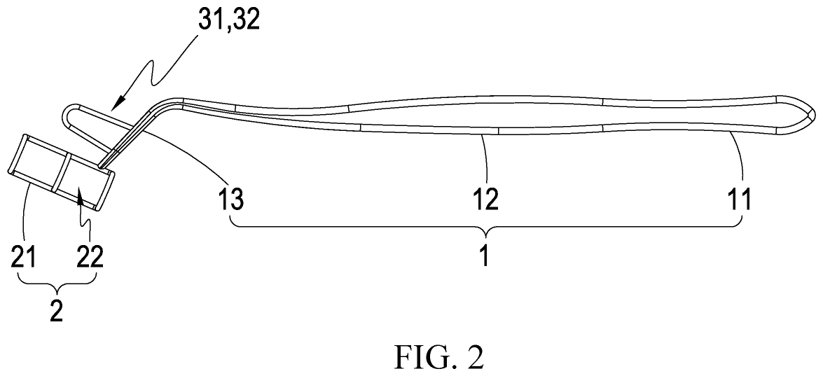

Referring to FIGS. 1 and 2, a dental forceps structure of the present invention, in a preferred embodiment, includes a fixture body 1, two accommodation elements 2 and two barriers 31, 32.

The fixture body 1 includes an elastic connecting portion 11, two elastic arms 12 formed on the two ends of the elastic connecting portion 11 and two bended clamping portions 13 each formed on one end of one of the elastic arms 12.

The two accommodation elements 2 are configured on the respective clamping portions 13, each of them has a countervailing limit 21, and at least one hollow portion 22 is defined between the two countervailing limits 21.

The two barriers 31, 32 are configured on the two respective clamping portions 13 and positioned between the accommodation elements 2 and fixture body 1; they are adapted to isolate the disturbance of surrounding tissues and organs.

With the above description, the structure of the present invention can be well understood. According to the corresponding match of the components, the present invention is structurally simple and conveniently operative, can fix a water suction element effectively, accurately prevent the disturbance of a tongue from interfering therapy, provide a physician's clear operational vision, and have advantages such as patient protection and medical accident prevention. The detailed explanation will be given in the following.

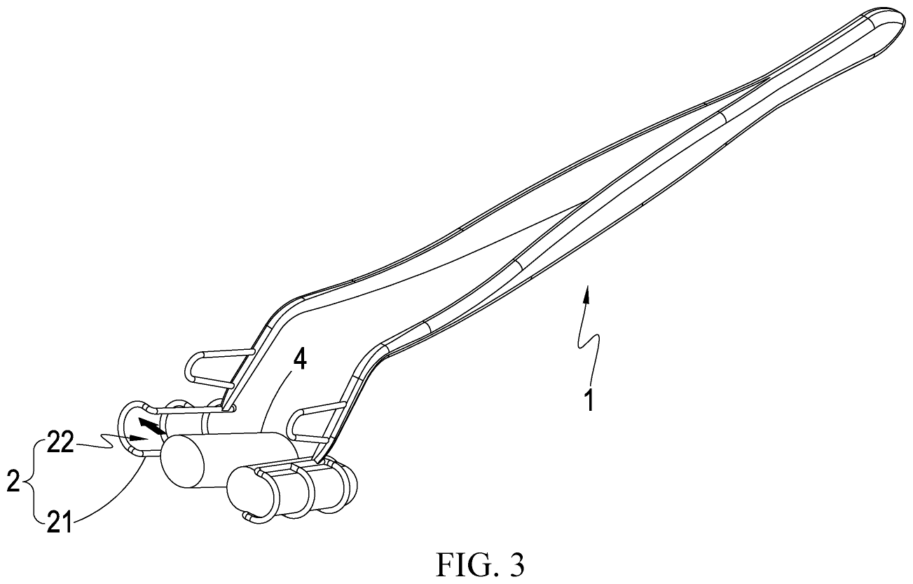

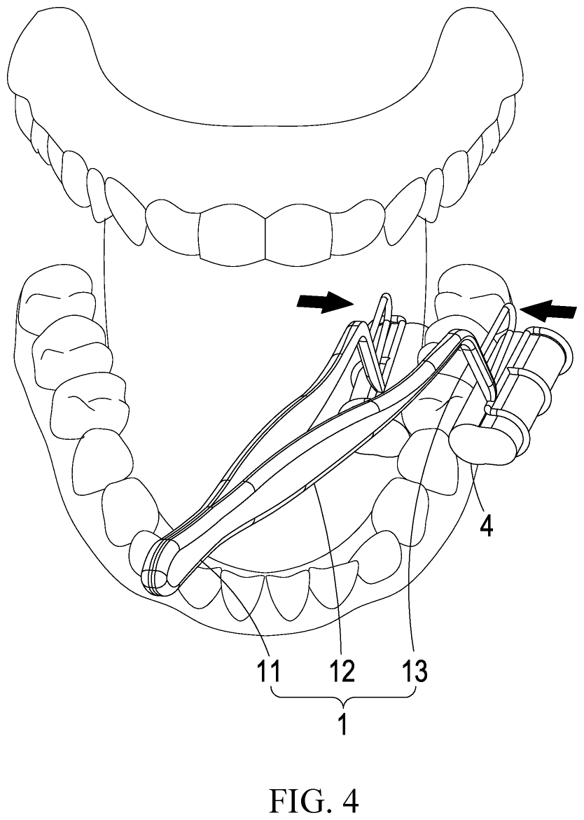

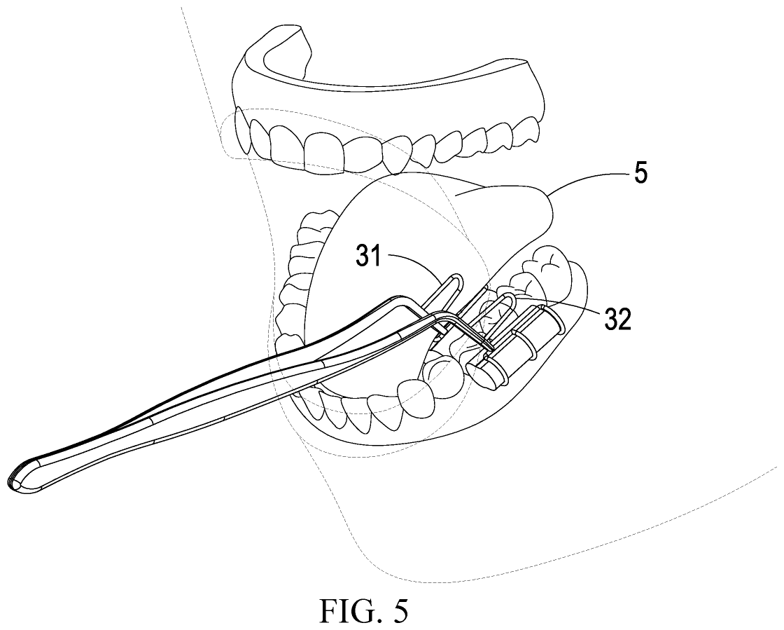

Referring to FIGS. 1 to 5, the fixture body 1 of the present invention has the downwardly bended clamping portions 13 each formed on one end of one of the elastic arms 12 away from the elastic connection portion 11 besides the elastic arms 12 allowing a user to grasp and the elastic connection portion 11 in connection with the elastic arms 12 and allowing the elastic arms 12 to be kept at a fixed angle when the above components are assembled, thereby allowing each clamping portion 13 and corresponding elastic arm 12 to approximately form a L-shaped body and allowing the fixture body 1 to be naturally straddled in the patient's mouth after a user fixes it. Therefore, multi-purpose dental forceps can then be formed with the design of the accommodation elements 2 and barriers 31, 32, where the accommodation elements 2 and barriers 31, 32 can be integrated with the fixture body 1 with a die casting mold or bonded to one side of the clamping portion 13 by means of thermal fusion.

In practical use, a user only needs to place a water suction element 4 such as gauze or lap between the accommodation elements 2, and then uses the countervailing limits 21 with a semi-cylindrical frame to fix the water suction element 4. Next, the elastic arms 12 of the fixture body 1 is manually pulled apart, and the clamping portions 13 of the fixture body 1 are placed on both sides of the affected part so as to contract the elastic arms 12 inward with the elastic force of the elastic connection portion 11, allowing the clamping portions 13 to be naturally fixed to the two sides of the affected part, thereby reducing the burden on the physician's operation and indeed positioning the water suction element 4, and the wetting condition of the water suction element 4 can be observed through the hollow portion 22. At the same time, the barrier 31 on the lingual side is used to prevent the disturbance of a tongue 5, and the outside barrier 32 is used to open the cheek, allowing the user's operational vision to be more clear and broad, further improving the efficiency and completeness of physician's treatment, and keeping the operation area dry and effectively preventing the water suction element 4 from being accidentally swallowed by the patient or dropped into the trachea during the treatment process.

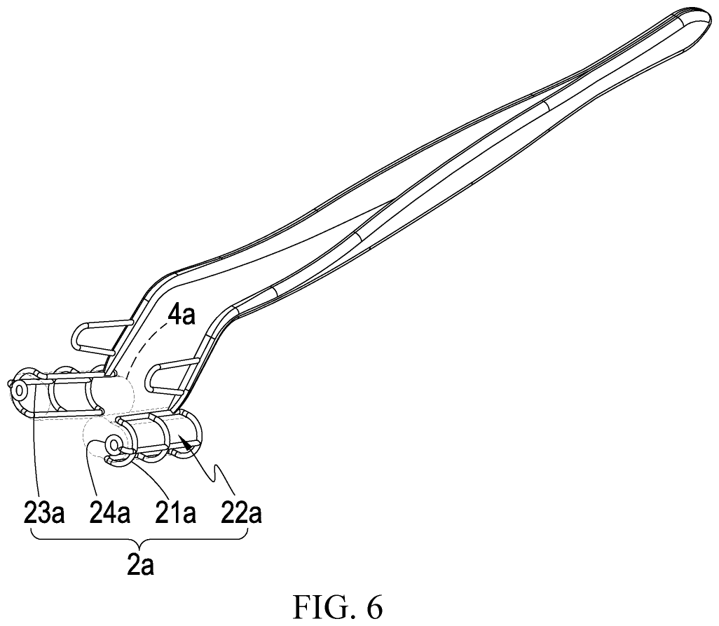

Referring to FIG. 6, which shows another preferred embodiment of the present invention, the present embodiment is almost similar to the above embodiment except that in the present embodiment, each countervailing limit 21A has at least one side blocking portion 23A positioned on the hollow portion 22A, and a rear blocking 24A is formed on one end of the side blocking portion 23A. whereby, the water suction element 4A can be positioned by the side blocking portion 23A and rear blocking portion 23A to prevent the water suction 4A from falling off from the hollow portion 22A due to overlarge force for stuffing the water suction element 4A when the water suction element 4A is stuffed between the accommodation elements 2A; the water suction element 4A is pushed to pressed against the rear blocking portion 24A to position it completely and stably between the accommodation elements 2A after stuffed between the accommodation elements 2A. At the same time, a patient's tongue can be prevented from ejecting the water suction element 4A out of the hollow portion 22A.

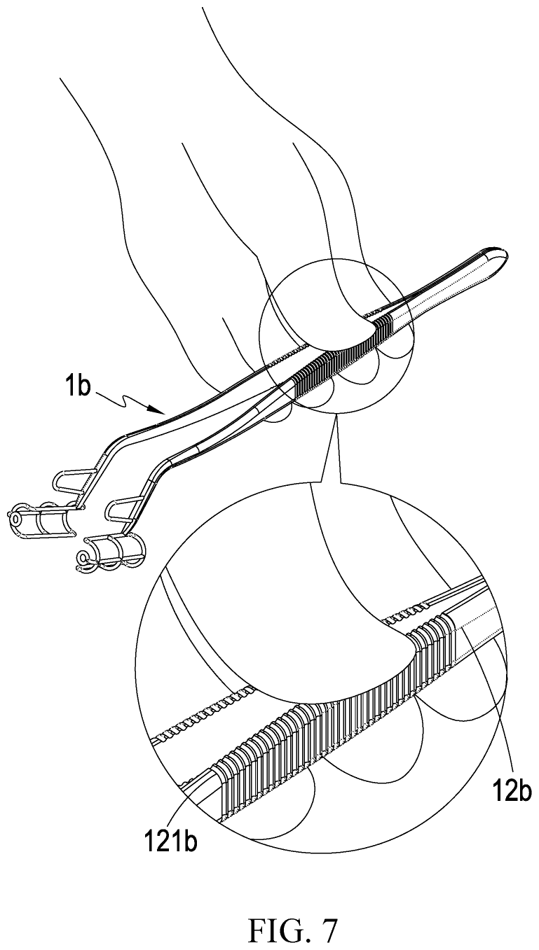

Referring to FIG. 7, which shows a still another preferred embodiment of the present invention, the present embodiment is almost similar to the above embodiments except that in the present invention, at least one anti-slip portion 121B is configured on each elastic arm 12B, where the anti-slip 121B is respectively mainly positioned on the upper surface and lower surface of the elastic arm 12B (the narrow sides thereof) or annularly configured on the periphery of the elastic arm 12B so as to increase the abrasion force of the fixture body 1B with the anti-slip portion 121B to increase user's holding stability when the fixture body 1B is held.

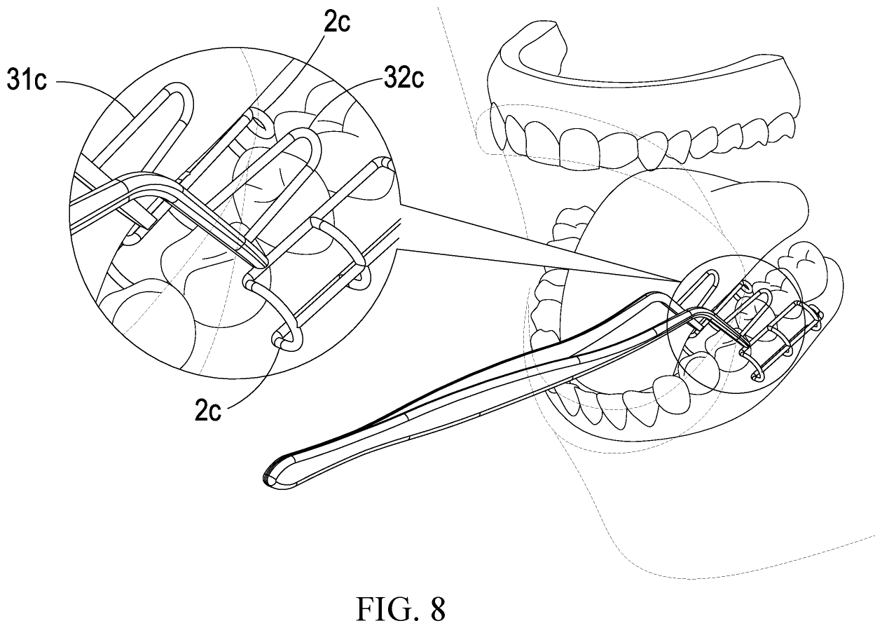

Furthermore, referring to FIG. 8, which show further another preferred embodiment of the present invention, the present invention is almost similar to the above embodiments except that the present embodiment is an operating area isolation situation of general decayed tooth cavity preparation and tooth surface preparation before gap filling; the frame volume of the accommodation element 2C is used to assist in isolating the tongue or cheek, while the barrier 31C, 32C are used to isolate the disturbance of surrounding tissue and organs, which effectively broaden the space and vision above the affected area, beneficial for doctors to operate equipment such as high-speed handheld units, and further avoiding the injury of patients with the equipment.

I claim:

1. A dental forceps structure, comprising:
a fixture body, comprising an elastic connection portion, two elastic arms formed on two ends of said elastic connection portion, and two bended clamping portions each formed on one end of one of said elastic arms;
two accommodation elements, each configured on one of said clamping portions; and
two barriers, configured on said respective clamping portions and positioned between said accommodation elements and fixture body, and adapted to isolate the disturbance of surrounding tissues and organs.

2. The structure according to claim 1, wherein each said clamping element has a countervailing limit, and at least one hollow portion is defined between said countervailing limits.

3. The structure according to claim 2, wherein each said countervailing limit has at least one side blocking portion positioned on said hollow portion.

4. The structure according to claim 3, wherein one end of each said side blocking portion is formed with a rear blocking portion.

5. The structure according to claim 3, wherein said countervailing limits are integrated with said side blocking portions.

6. The structure according to claim 1, wherein a water suction element is stuffed between said accommodation elements.

7. The structure according to claim 6, wherein said water suction element is a gauze or lap.

8. The structure according to claim 1, wherein each said elastic arm has at least one anti-slip.
